(19) United States
(12) Patent Application Publication
(10) Pub. No.: US 2011/0179073 A1
(43) Pub. Date: Jul. 21, 2011

(54) Method for Localizing Text in a Software Application

(75) Inventor: Christoffer Nilsson, Helsingborg (SE)

(73) Assignee: Localize Direct AB

(21) Appl. No.: 13/121,211

(22) PCT Filed: Oct. 8, 2009
(86) PCT No.: PCT/SE09/51119

§ 371 Date: Mar. 28, 2011

Related U.S. Application Data
(60) Provisional application No. 61/103,690, filed on Oct. 8, 2008.

(51) Int. Cl. G06F 17/30

(52) U.S. Cl. 707/769; 707/812; 707/E17.005; 707/E17.014

(57) ABSTRACT

The present invention relates to a method for localizing text in a software application by means of allowing concurrent input and localization of e.g. text strings. The invention also relates to a corresponding server and a system comprising such a server and at least a first and a second client. By means of allowing multiple access of the database from more than one user at essentially the same time it may be possible to allow for the first user to at any time provide a source data input that at any time may be accessed by the second user and localized in a target language. Accordingly, it may be possible to shorten the development time of the software application.

### TECHNICAL FIELD

The present invention relates to a method for localization of a software application. The present invention also relates to a corresponding server and computer program product for localizing a software application.

### BACKGROUND OF THE INVENTION

To increase sales of a software application it can be helpful to have the software application localized into the languages where one plans on market and sell the software application. With the global markets today many applications are localized into multiple languages. A large scale software application can contain hundreds of thousands of words that need to be translated into multiple languages and then implemented back into the application and tested before the application can be shipped. Translation is usually done offsite away from where the computer application is developed as it is preferred to use translators living in an area where they speak the target language as well as the target language being the translator's mother language.

An exemplary approach for localizing a software application is disclosed U.S. Pat. No. 5,678,039, using a Software Translation Kit (STK) system having a shell coupled to an export/import module. The export/import module parses a resource file into a translation table, which is typically stored as a database table. The translation table encapsulates all the information that is known or can be derived from the various resources and stores them in a format which may be utilized by various editors. Using editors, such as e.g. a string editor, a translator can easily access and manipulate the various resources of the program for carrying out translation. The translations themselves are stored back in the translation table. Once the translator has completed the task of translating the resources, the translated text is merged back using the export/import module for generating a translated resource file. The translated resource file is similar to the original resource file, except that any necessary translations (e.g. translating an English text string into a French text string) have been carried out. Once the translated resource file has been generated, the target application is rebuilt with the new sources. The file may be simply stored back with the source files, as a translated resource file(s); or, the translated resource file may be compiled and bound back into the target program directly. In either instance, the underlying program code (i.e. the code which the programmer has written to carry out the functionality of the program) has remained untouched by the process.

There are however problems with the approach disclosed in U.S. Pat. No. 5,678,039. For example, the disclosed localization process delays the release of the software application as localization can not start until all strings in the source language have been entered—which they usually have not been until the very end of the development phase. Another usual problem is that the developer gets version problems. That is, if a string is changed by the developer in the source language after it has been sent off to translators then the changed string in the file that the translator works on is out of date and may have a completely different meaning. If this is not dealt with the target language may contain strings with totally different meanings. The developer may also find themselves in the position of having to add new strings although the separated strings have already been sent off for translation, then these new strings have to be separated from the previously separated strings and dealt with in a separate batch adding to the complexity.

Accordingly, it may be desirable to provide improvements in relation to localization of a software application, specifically in relation to decreasing the time to market.

### SUMMARY OF THE INVENTION

According to an aspect of the invention, the above is at least partly met by a method for localizing text in a software application using a network connected server comprising a database, the method comprising the steps of (a) receiving a source data input from a first user using a first network connected user controlled client configured to access the database, the source data input comprising a source language string and a string identifier, (b) storing the source data input in the database, (c) receiving a localized data input from a second user using a second network connected user controlled client configured to access the database, the localized data input corresponding to the source data input and comprising a localized text string of the source language string and a language identifier, (d) storing the localization data input in the database, (e) marking the source language string in the database as localized in a target language indicated by the language identifier; and (f) generating at least one data file comprising a predetermined selection of the content from the database in a predetermined data format, wherein steps (a), (b), (c), (d), (e) and (f) are executed concurrently.

By means of allowing multiple access of the database from more than one user at essentially the same time it may be possible to allow for the first user to at any time provide a source data input that at any time may be accessed by the second user and localized in a target language. Accordingly, it may be possible to shorten the development time of the software application, allowing concurrent translation during development process, increasing control over localization process, making it easier to access strings for non-programmers,

even out translator's workload and making it easier to manage string changes.

Furthermore, by allowing the first user to provide additional information in relation to the source data input, e.g. by allowing the source input data to further comprise a string length size restriction, it may be possible to reduce the problem with too long “bleeding strings”, as it may be possible to in advance set a maximum string length. More specifically, strings that show up as text on the screen when the application runs might have limited size available on the screen. The translated strings will be different in length and they might “bleed” into other graphical properties on the screen or into the border of the screen. In many development projects for software applications, such as for example a video game, there are multiple users (e.g. first user) that may need to add new source language or edit strings. In a video game there would be a programmer working with the menu system that may need to add new source language strings as well as a designer who needs to add text strings containing story elements. For non-programmers it can be difficult to add new strings or edit old as they are separated and indexed.

In an embodiment, the steps of receiving as well as storing the source data input are repeated for a plurality of source data inputs. Correspondingly, the steps of receiving and storing the localized data input as well as marking the source language string in the database as localized are repeated for a plurality of corresponding localized data inputs.

Accordingly, for a user working on translating the text (e.g. the second user) of the software application using above mentioned method, it is possible to allow for translators to start translating as soon as the first source language string has been defined, and instantly make available any addition source language strings as soon as they have been entered into the application. Furthermore, the method allows for a mechanism where the application developers and translators work on the same data. Accordingly, it is possible to automatically separating out the source language strings, target language strings and organized them and the string identifiers in a way so that they could be included in the build process of the application or accessed/loaded at runtime.

Preferably, the step of generating at least one data file is repeated until step (e) has been completed for the plurality of localized data inputs.

Exemplary, the step of generating the at least one data file is executed on a predefined command on a target computer, such as the first or the second client of the first or the second user. However, the target computer may also be the server. It should also be noted that the first and the second users may be the same user and the first and the second clients may be the same client.

Alternatively, the at least one data file may be automatically generated as soon as any update/change has taken place in the database. Additionally, the method preferably comprises the step of using the at least one data file in the software application, e.g. to be loaded at run time (comprising being loaded over the Internet) possibly also allowing for strings and languages to be added even after the application has been released. This allows for further improvements in relation to seamless and instant integration of translations into the software application. That is, as soon as a string has been localized, there may automatically be provided a data file for use with the software application at a next compilation/run. Alternatively, the software application may be constructed in such a way that it seamlessly requests and downloads the data file if an updated data file is available (e.g. over the Internet).

For facilitating for e.g. a manager having responsibility of the translation processes it may be desirable to have constant control of the translation process. Accordingly, the method may further comprise the steps of determining the number of localized data inputs (e.g. in relation to the number of source language words) in the database and communicating the number of localized data inputs to at least one of the first, the second or a third user, such as the manager. The result may be displayed as for example a translation progress diagram. Preferably, it is desirable to provide information relating to the amount of source language words, amount of localized words in different languages, amount of source language strings, and/or amount of translated target language strings.

In a preferred embodiment of the invention, the method further comprise the steps of comparing the localized text string with a predetermined list of non-selectable text strings, and if the comparison provides a match, communicating a notification of the non-selectable text string and/or in combination with a preferable substitute text string to at least one of the first, the second or the third user. Such a predetermined list may e.g. comprise a plurality of “black listed words” not suitable for use in relation to e.g. a software application. The predetermined list may be continuously updated.

Similarly, the method may preferably further comprise the steps of comparing the source data input with a list of previously localized data inputs, and if the comparison provides a match, storing the localization data input from the list in the database. Using such an approach it may be possible to reuse earlier translations, e.g. localized text strings, from for example an earlier version of the software application.

The source data input and the corresponding localized data input further comprises at least one of an audio portion and a video portion,

According to another aspect of the invention, there is provided a server for localizing text in a software application, the server being network connected and comprising a database, the server comprising means for acquiring a source data input from a first user using a first network connected user controlled client, the source data input comprising a source language string and a string identifier, means for storing the source data input in the database, means for acquiring a localized data input from a second user using a second network connected user controlled client, the localized data input corresponding to the source data input and comprising a localized text string of the source language string and a language identifier, means for storing the localization data input in the database, and means for marking the source language string in the database as localized in a target language indicated by the language identifier, means for generating at least one data file comprising a predetermined selection of the content from the database in a predetermined data format, wherein the means for acquiring a source data input and the means for acquiring a localized data input are accessed concurrently. This aspect of the invention provides similar advantages as discussed above in relation to the previous aspect of the invention. It should furthermore be noted that the functionality of the server may be incorporated with e.g. a first and a second client for forming a localization system.

According to a still further aspect of the present invention there is provided a computer program product comprising a computer readable medium having stored thereon computer program code for causing a server comprising a database to provide a method for localizing text in a software application, wherein the computer program product comprises code for acquiring a source data input from a first user using a first network connected user controlled client, the source data input comprising a source language string and a string identifier, code for storing the source data input in the database, code for acquiring a localized data input from a second user using a second network connected user controlled client, the localized data input corresponding to the source data input and comprising a localized text string of the source language string and a language identifier, code for storing the localization data input in the database, code for marking the source language string in the database as localized in a target language indicated by the language identifier; and code for generating at least one data file comprising a predetermined selection of the content from the database in a predetermined data format, wherein the code for acquiring a source data input and the code for acquiring a localized data input are executed concurrently.

The computer readable medium may be one of a removable nonvolatile random access memory, a hard disk drive, a floppy disk, a CD-ROM, a DVD-ROM, a USB memory, an SD memory card, or a similar computer readable medium known in the art.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 depicts a data processing system network in which a preferred embodiment of the present invention may be implemented;

FIG. 2 is a high level flowchart of a software development cycle including localization;

FIG. 3 is a high level flowchart of a software development cycle according to one embodiment of the present invention;

FIG. 4 is a high level flowchart of the login and main loop process according to one embodiment of the present invention;

FIG. 5 is a list of menu options according to one embodiment of the present invention;

FIG. 6 is a flowchart of adding new source language string data process according to one embodiment of the present invention;

FIG. 7 is a flowchart of editing source language string data according to one embodiment of the present invention;

FIG. 8 is a flowchart of the translate process according to one embodiment of the present invention;

FIG. 9 is a flowchart of the proofread process according to one embodiment of the present invention; and

FIG. 10 is a flowchart of the import process according to one embodiment of the present invention.

### DEFINITIONS

String: When referred to here, a string means an ordered sequence of symbols. The symbols are chosen from a predetermined set or alphabet such as ASCII or Unicode. It is preferred to use Unicode as it supports more languages. The length of a string is the number of symbols in the string and can be any non-negative integer. In a application one would for example use strings to hold text and information one would like to present to the user. A string can be any length provided it fits within the memory limitations of the system. A string can amongst other things be a character, a word, several words, a sentence or several sentences. Normally in a application a string would contain a block of text that is processed together. For example a menu option “Save As” would be one string. A help text describing a function with several sentences could also be stored in one string.

String identifier: A string identifier is a unique reference to a string. Following is an example of one way to use string identifiers for software language localization. Let's assume that the language used during development is English and that the software application once it is finished, should be able to display all text in English, French and German.

Rather than entering the English string in the source code the programmer(s) uses a string identifier reference. This string identifier is normally a variable or a “define”, a text that equals an index number. This index number is then used to lookup the correct English string that are stored in memory or in a file.

| Index | | |
|---|---|---|
| number | String identifier | English string |
| 1 | STR_SAVE_SETTINGS | Save Settings |
| 2 | STR_LOAD_SETTINGS | Load Settings |

In the table above the string identifier STR_SAVE_SETTINGS=1 and the string “Save Settings” is stored in the 1:st position in the list of English strings. The string identifier STR_LOAD_SETTINGS=2 and the string “Load Settings” is stored in the 2:nd position in the list of English strings.

For additional languages translated strings are stored in exactly the same order as their English counterparts. Adding French and German the table may look like:

| Index | | English | | |
|---|---|---|---|---|
| number | String identifier | string | French string | German string |
| 1 | STR_SAVE_SETTINGS | Save | Sauvegarder | Einstellungen |
| | | Settings | réglages | speichern |
| 2 | STR_LOAD_SETTINGS | Load | Charger | Einstellungen |
| | | Settings | réglages | laden |

The English, French and German string columns may be saved in separate files. The index number and string identifier may be saved in a file that the compiler can read and include in the code. When the program is to display a string it receives the index number and uses this to lookup the corresponding string in the language the user has selected.

String folder: Refers to a container for one or several strings. It may be used to organize strings in a similar fashion that directories are used to organize computer files on a storage device. A folder can have multiple sub-folders. Folders can have user definable defaults that new strings generated in the folder will inherit. Also sub-folders will inherit the parent folders user definable defaults.

Source language: Refers to a designated source language used to develop the software. This language is then translated into one or several target languages.

Target language(s): Refers to a language(s) that the software is chosen to be localized to. In the example under string identifier, English would be the source language and French and German would be the target languages. The final localized software in the example would feature text in English, French and German.

Source language string: Refers to a string in the source language.

Target language string: Refers to a string in the target language.

User definable string data: Refers to user definable data and or settings that are included with each source string. This data can be set by the user and can be included in any export and in the generate build data.

Source language string data: Refers to a source language string and any additional data. Such additional data may include but not limited to; date and time information of when string was entered into system, information about which user entered the string, a string identifier, any size limitations for the string, font information, alignment information, comments for translators, user definable string data, date information of when string should be issued to translators for translation, information if string will have audio files attached to it, audio file, graphic bitmap file, animation file, a computer file, proofread status, dialogue information, subtitle information, user definable string rules that translated strings has to conform to.

Target language string data: Refers to a target language string and any additional data. Such additional data may include but not limited to; date and time information of when target language string data was entered into system, information about which user entered the target language string data, comments from translators, information if string will have audio files attached to it, audio file, graphic bitmap file, a computer file, proofread status, user definable string data, translation status.

Command sequence: A command sequence may be a sequence of characters, a subset of a string, which the program using the strings recognizes at run time and issues a special routine for. For example “% d” might be used to indicate that at this specific position in the string the program should include a decimal number that would replace the command sequence on screen.

User definable string rule: Such user definable checks includes but not limited to; minimum and maximum amount of characters, alphabetic characters, numeric characters, lower and upper case, check so that any target language strings contain the matching and the same amount of command sequences as the source language string.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

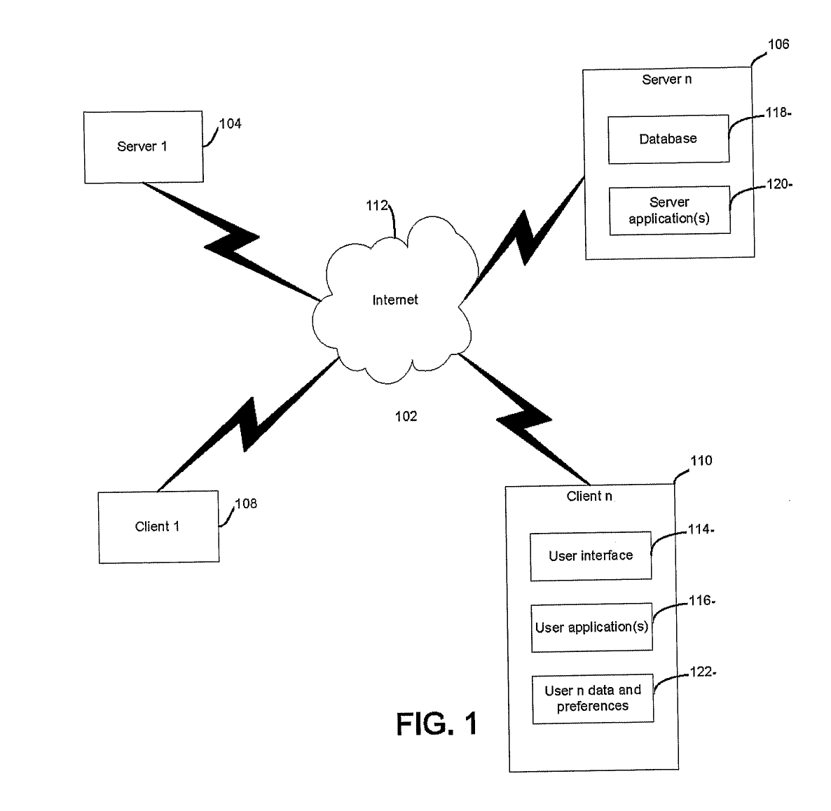

With reference now to the figures, and in particular with reference to FIG. 1 there is depicted a data processing system network in which a preferred embodiment of the present invention may be implemented. Data processing system network 102 includes one or more of servers 104-106 and one or more clients 108-110. Servers 104-106 and clients 108-110 (e.g. comprising the first and the second user controlled clients) exchange data, through the e.g. a communication network, such as the Internet 112, in accordance with the known art, utilizing, for example, the Transmission Convergence Protocol/Internet Protocol (TCP/IP) for data transfers.

Clients within data processing system network 102, such as client 110, include a user interface 114 which interacts with users and is connected with client 110. Client 110 may execute one or more user applications 116 which may be connected to user interface 114 and are capable of retrieval of data over Internet 112 from servers 104 or 106. Client 110 may utilize multiple sets of data such as user data and preferences 122.

Servers within data processing system network 102, such as server 106, include a database 118 and may include one or more server applications 120. Database 118 may be accessible to client 110 directly and to user application 116 or via server application 120. Server application 120 may access database 118 and connect with a client such as client 110 via the Internet 112.

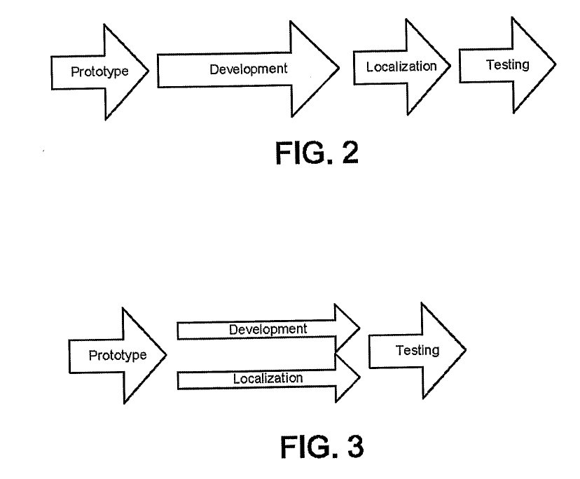

For reference and understanding of the invention, FIG. 2 shows a high level flowchart of a development process where localization is carried out at the end of the development period once all the source language strings are entered, i.e. according to a prior art approach. In comparison, FIG. 3 shows a high level flowchart of a development process where localization is carried out during the development period, i.e. in accordance to the present invention.

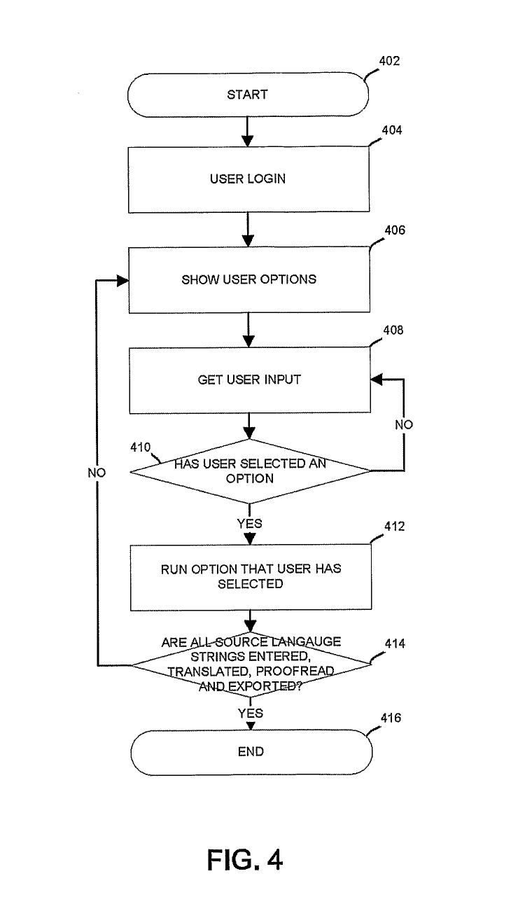

Further below it will be given an example of operating the system according to the invention for performing the inventive method. However, for understanding of the invention, FIGS. 4-10 are initially discussed for providing reference to specific, possibly optional steps, performed by the user of the system and of the system itself.

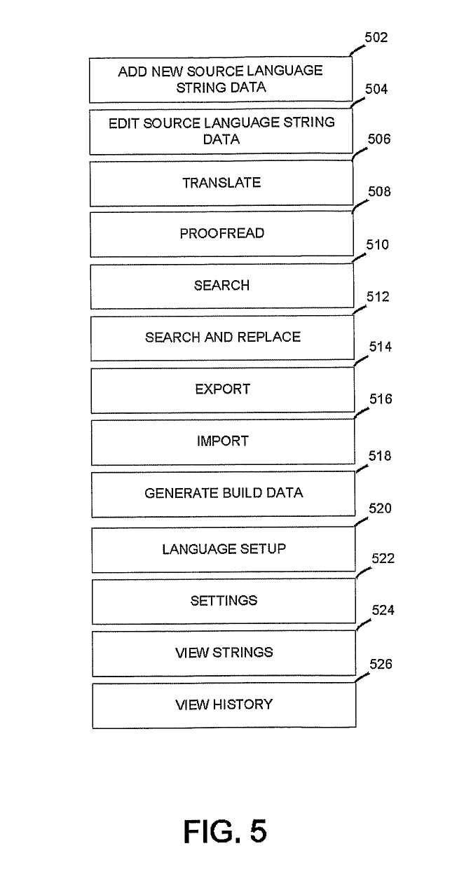

Turning initially to FIG. 4, shows a flowchart of the login and main menu process. The process begins (step 402) when a user enters a valid user name and password (step 404). A set of options including but not limited to list in FIG. 5 is made available to the user (step 406-410). Once the user has made a choice the selected option is executed (step 412). On returning from the executed option (step 414) a part of the process is repeated (back to step 406) until all source language string data is entered, all source language strings have been translated and proofread and final export of the database data has been exported.

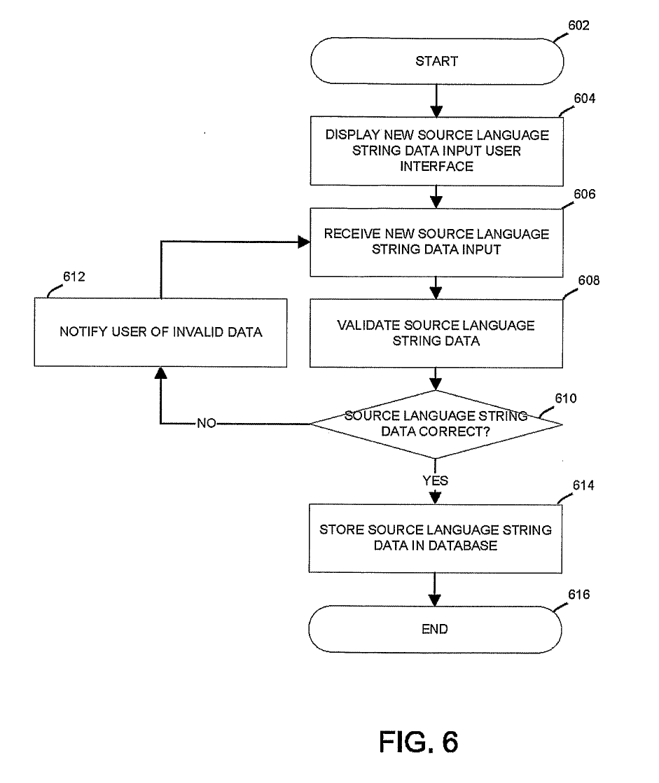

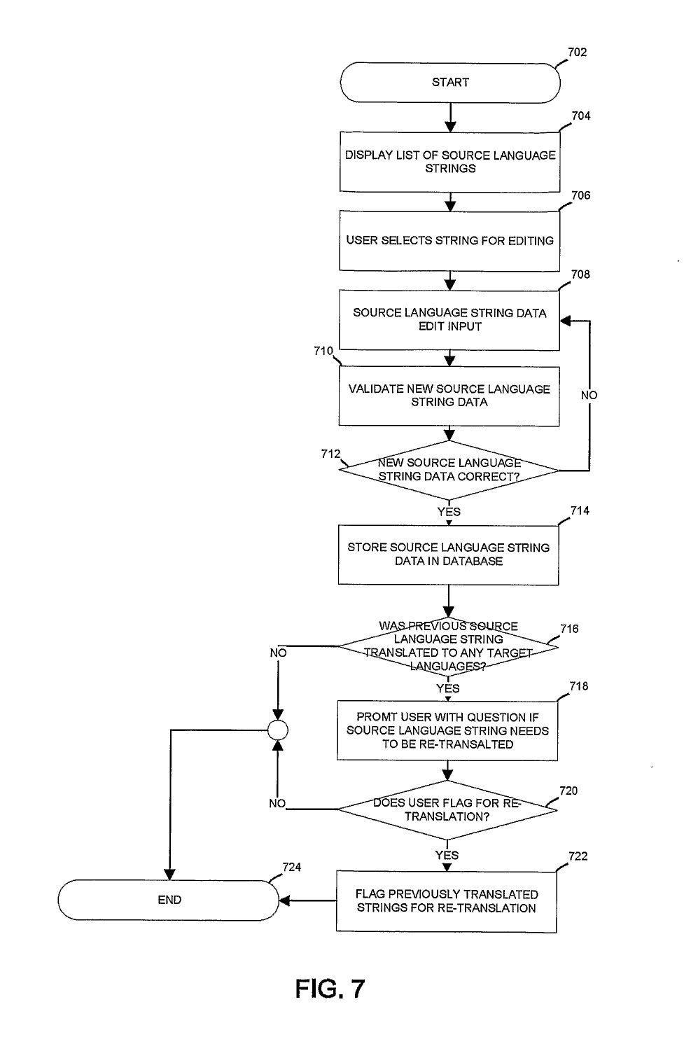

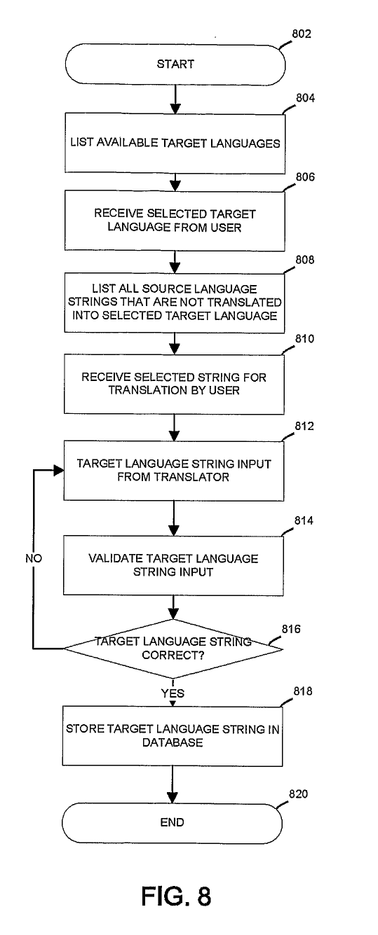

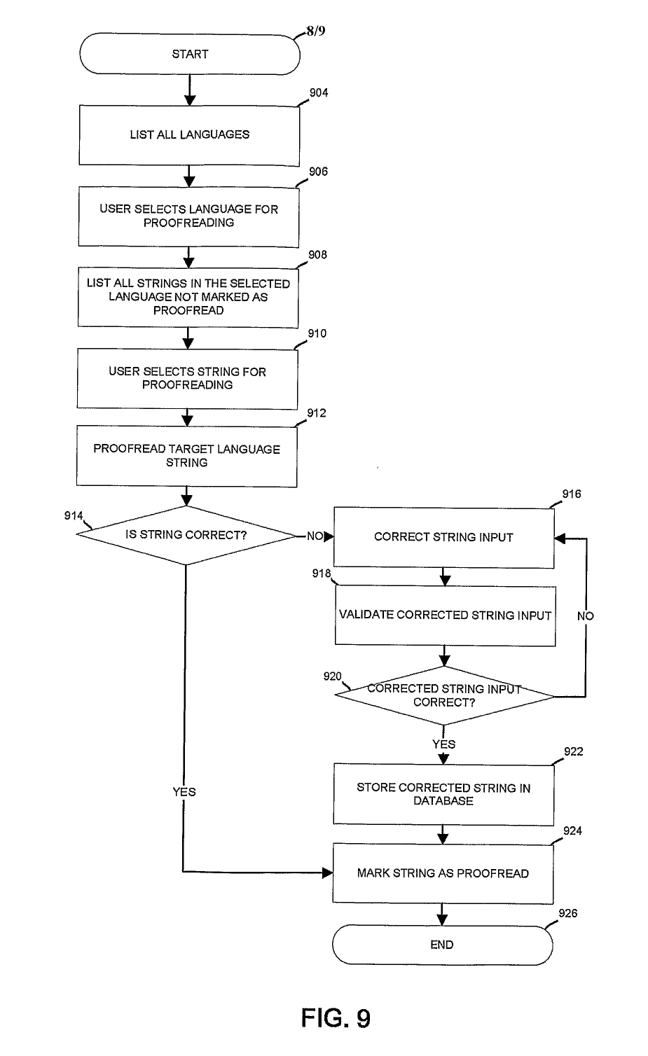

Accordingly, FIG. 5 shows a list of menu options available but not limited to according to one embodiment of the present invention. Option “Add new source language string data” (option 502) is described in FIG. 6. Option “Edit source language string data” (option 504) is described in FIG. 7. Option “Translate” (option 506) is described in FIG. 8. Option “Proofread” (option 508) is described below in relation to FIG. 9.

Option “Search” (option 510) receives from the user a search criteria including but not limited to which languages to include in search, period start and stop date for when strings was entered or changed, wildcards, text to include in search, text to exclude from search and entered by user. The search setup can be saved and quickly retrieved for later use. The presentation of the search result is also configurable by the user. The search results can be exported.

Option “Search and replace” (option 512) receives from the user a search criteria including but not limited to which languages to include in search, period start and stop date for when strings was entered or changed, wildcards, text to include in search, text to exclude from search and entered by user together with replacement text. When a match is found the matching text is replaced with the replacement text and the process continues until all texts have been tested. The result of the search and replace is presented to the user.

Option “Export” (option 514) exports data from the database in customizable format. An export will generate a data file. The exported data can be added to and changed using external software and editors such as MS Word or MS Excel and then be imported back into the system. For example a user might export data, add translations into one target language to the exported data and then import it back into the system together with the added translations. The user can also define what data should be included in the export this includes but not limited to; string identifier, source language string, date of last change, name of user making last change, and existing translations into any target language.

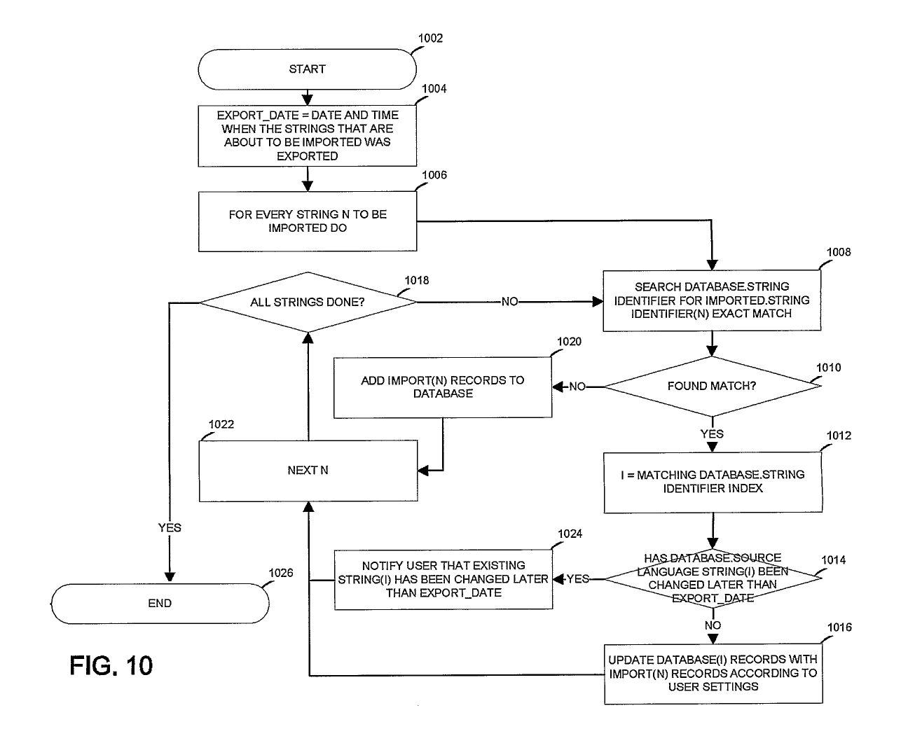

With reference to FIG. 10, option “Import” (option 516) imports data into the system.

Option “Generate build data” (option 518) generates data from the database in a customizable format. This customizable data can be included in the software that is to be localized during compiling or loaded at runtime. The data can output into one or several files. The data in the files includes but not limited to the source language string identifier(s), source language string, all target language strings. The structures of the files are ordered in a way or contain data so that it is possible to locate source language string identifiers with their corresponding source language string and target language strings. It is possible for the user to enable automatic generation of build data when there's any change to the database such as a new source language string is entered, an existing source language string has been edited or a string has been translated.

Option “Language setup” (option 520) receives from the user which language is the source language and what the target language(s) are.

Option “Settings” (option 522) receives from the user different settings including but not limited to; user settings, user access rights, font setup, string folder setups, default setup, project setup, user definable string data setup, generate build data setup.

Option “View strings” (option 524) displays data from the database using customizable filters. The customizable filters includes but not limited to; data and time interval, added by user, last changed by user, source language strings, target language strings, source language string data, target language string data, user definable string data, string folders. Clicking on a string brings it up and allows the user to edit or add to the string data.

Option “View history” (option 526) displays previous events using user customizable filters. The customizable filters includes but not limited to; data and time interval, added by user, last changed by user, string folders.

With reference now to FIG. 6, illustrating a flowchart of adding new source language string data process according to one embodiment of the present invention. The process starts (step 602) by displaying an input user interface (step 604) where the user can enter source language string data. Once such source language string data has been received (step 606) a validation process is performed (step 608) to make sure that the entered source language string data is correct and valid. The validation process (step 608) includes but not limited to checking that any entered string identifier is unique and doesn't already exist. If the entered data does not pass the validation process (step 610) then the user is notified about the invalid data (step 612) and the system waits for a new source language string input (step 606). Once the source language string data has passed the validation process (step 610) the source language string data is stored in the database (step 614) and the process ends (step 616).

With reference now to FIG. 7, illustrating a flowchart of editing source language string data according to one embodiment of the present invention. The process starts (step 702) by displaying a list of source language strings (step 704). The user selects a source language string for editing (step 706) and the selected source language string data is made available to the user so that the user may edit the source language string data (step 708). Once an edit input is made the edited source language string data is validated (step 710). The validation process includes but not limited to checking that any edited string identifier is unique and doesn't already exist. If the edited source language string data (712) does not pass the validation process the user is notified about the invalid data and the process waits for the user to input the edited source language string data again (step 708).

If the edited source language string data (step 712) is valid then store the edited source language string data in the database (step 714). A check is made to see if the edited source language string already was translated to any of the target languages (step 716). If the edited source language string (step 716) had not been translated to any of the target languages the process ends (step 724). If the edited source language string (step 716) already was translated to any of the target languages the user is asked if the edited source language string needs to be re-translated (step 718). If the user answers (step 720) that no re-translation is necessary the process ends (step 724). If the user answers (step 720) that re-translation is necessary any previously translated versions of the edited source language string are flagged for re-translation (step 722) and the process ends (step 724).

With reference now to FIG. 8, illustrating a flowchart of the translate process according to one embodiment of the present invention. The process starts (step 802) by listing all target languages available to the user (step 804), this can be defined by the system administrator. The user selects a target language (step 806). All source language strings that are not translated into the selected target language or strings that has been flagged for re-translation are listed using user definable filters (step 808). Such user definable filters including but not limited to; string folders, string entered/changed during specified time period, string entered or changed by specified user.

A string selected for translation into the selected target language is received from the user (step 810). The user is prompted with an input box where user can enter the translation (step 812). A validation check is made on the entered translation (step 814). This validation includes but not limited to; optional length check of entered translation, optional check to make sure that the entered translation has the same command sequences as the source language string and any user definable string rules. If the entered translation to the target language (step 816) is invalid the user is notified about the invalid content and asked to re-enter the string (step 812). If the entered translation to the target language (step 816) is valid the entered translation to the target language is stored in the database (step 818) and the process ends (step 820).

With reference now to FIG. 9, illustrating a flowchart of the proofread process according to one embodiment of the present invention. The process starts (step 902) by listing all available languages (step 904), this includes the source language and the target languages. The user selects a language for proofreading (step 906). All strings in the selected language that are not marked as proofread is listed (step 908). The list can use user definable filters including but not limited to; string folders, string entered/changed during specified time period, string entered or changed by specified user. The user selects a string for proofreading (step 910). If the selected string is not in the source language but rather in one of the target languages then the source language version of the string is also displayed to the user.

The user proofreads the selected string (step 912). If the selected string (step 914) is correct the selected string in the selected language is marked as proofread in the database (step 924) and the process ends (step 926). If the selected string (step 914) is not correct the user can input a corrected string (step 916). A validation check is made on the corrected string input (step 918).

This validation includes but is not limited to; optional length check of entered translation, optional check to make sure that the entered translation has the same command sequences as the source language string and any user definable string rules. If the corrected string input (step 920) is not correct, the user is notified about the invalid content and can re-enter the string (step 916). If the corrected string input (step 920) is correct the corrected string input is stored in the database (step 922) and the selected string in the selected language is marked as proofread (step 924) in the database and the process ends (step 926).

With reference now to FIG. 10, illustrating a flowchart of the import process according to one embodiment of the present invention. The process starts (step 1002). export_date means the date and time when the strings that are about to be imported was exported (step 1004) this information is retrieved either from the user, the import file data or log event of when export was made. A loop (step 1006) for every string (n) to be imported is initiated.

The existing string identifiers in the database are searched to find if an exact matching string identifier to the imported string identifier exists (step 1008). If a match (step 1010) is not found then depending on user settings, either; add import(n) records to database (step 1020) or notify user and skip import, then continue the loop and process next string (1022), if all strings (step 1018) are done, then end process (step 1026) else repeat loop (step 1008). If a match (step 1010) is found then let i=matching database.string.identifier index (step 1012). Check if database.source.language.string(i) has been changed later than export_date (step 1014). If database.source.language.string(i) (step 1014) has not been changed later than export_date then update database(i) records with import(n) records according to user settings and flag the string translated in the target language(s) contained in the import (step 1016), then continue the loop and process next string (1022), if all strings (step 1018) are done, then end process (step 1026) else repeat loop (step 1008).

If database.source.language.string(i) (step 1014) has been changed later than export_date then notify user that existing string(i) has been changed later than export_date, then continue the loop and process next string (1022), if all strings (step 1018) are done, then end process (step 1026) else repeat loop (step 1008).

During an exemplary operation of the system, an administrator uses a client 110, to setup source and target languages 520 and settings 522 including users access rights and defining the generate build data structure so that it can be included in the building process of the application or accessed during runtime.

An application developer or several developers uses the client 110, logs into the system step 404, selects option step 502, and enters new source language string data FIG. 6, depending on the settings either the application developer(s) manually generates build data 518 or the system will do it automatically. The developer can also set any other additional source language string data such as a size limitation for the string and any of the translation(s) of the string. If feasible the application developer(s) can set date information of when the string should be issued to translators for translation.

This can be useful if the application developer wishes to try out a string and not wanting to make the string immediately available for translation. The new source language string is now available to the application programmer(s) to use in his/her application. Should there be a need to edit an existing source language string a user would log into the system step 404, select option 504, and edit the source language string data FIG. 7. The application programmer(s) keeps repeating the steps above for each and every string that is to be localized in the application. Concurrently as the application developer(s) enters source language strings one or several translators uses the client 110, logs into the system step 404, selects option step 506, and translates the available source language strings into the selected target language(s) FIG. 8.

As soon as a source language string has been translated into any of the target languages it will be part of the data generated by the generate build data 518 process. This makes it possible for the application developer(s) to have a fully localized application during the development, which they can test. Concurrently as one or several translators translates the existing source language strings a user can start the proofreading process by using the client 110, logging into the system step 404, selecting option proofread 508 and start the proofreading process FIG. 9.

A user can export data from the system using process 514. This can be useful if there is a need to add or change data using other application than the invention. Any such added to or altered data can be imported back into the system using the import function 516 with the process described in FIG. 10.

A user may search the strings in the database by using function 510. A user may also search and replace strings or part of a string in the database using function 512. A user can view the strings in the database by using function 524. Additionally, a user may track the activity in the system by using function 526. Some applications contain human speech which is also to be localized. It is possible for a user to use the client 110, log into the system step 404, selecting option “View strings” 524 and attach audio files to the source language strings and the target language strings. This audio data would then be accessible to the application developer(s) through the “Generate build data” function 518.

Even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. For example, even though the description above has been given relation to interaction with the inventive method by means of a dedicated client, the user(s) may also interact with the server my means of an API. This allows for adaptation of a user specific e.g. development or translation application to provide the client side of the inventive method, e.g. by means of function calls to the API.

Furthermore, in the claims, the word “comprising” does not exclude other elements or steps, and the indefinite article “a” or “an” does not exclude a plurality.

1. A method for localizing text in a software application using a network connected server comprising a database, the method comprising the steps of:
(a) receiving a source data input from a first user using a first network connected user controlled client configured to access the database, the source data input comprising a source language string and a string identifier;
(b) storing the source data input in the database;
(c) receiving a localized data input from a second user using a second network connected user controlled client configured to access the database, the localized data input corresponding to the source data input and comprising a localized text string of the source language string and a language identifier;
(d) storing the localization data input in the database;
(e) marking the source language string in the database as localized in a target language indicated by the language identifier; and
(f) generating at least one data file comprising a predetermined selection of the content from the database in a predetermined data format, wherein steps (a), (b), (c), (d), (e) and (f) are executed concurrently.

2. Method according to claim 1, wherein steps (a) and (b) are repeated for a plurality of source data inputs.

3. Method according to claim 2, wherein steps (c), (d) and (e) are repeated for a plurality of corresponding localized data inputs.

4. Method according to claim 3, wherein step (f) is repeated until step (e) has been completed for the plurality of localized data inputs.

5. Method according to any one of the preceding claims, wherein the step of generating at least one data file is executed on at least one of a predefined command on a target computer and on a change to the database.

6. Method according to any one of the preceding claims, further comprising the step of using the at least one data file in the software application.

7. Method according to any one of the preceding claims, wherein the first and the second users are the same user and the first and the second clients is the same client.

8. Method according to any one of the preceding claims, further comprising the steps of determining the number of localized data inputs in the database and communicating the number of localized data inputs to at least one of the first, the second or a third user.

9. Method according to any one of the preceding claims, further comprising the steps of comparing the localized text string with a predetermined list of non-selectable text strings, and if the comparison provides a match, communicating a notification of the matching non-selectable text string to at least one of the first, the second or the third user.

10. Method according to any one of the preceding claims, further comprising the steps of comparing the source data input with a list of previously localized data inputs, and if the comparison provides a match, storing the localization data input from the list in the database.

11. Method according to any one of the preceding claims, wherein the source data input and the corresponding localized data input further comprises at least one of an audio portion and a video portion.

12. Method according to any one of the preceding claims, wherein the source data input further comprises a string length size restriction.

13. Server for localizing text in a software application, the server being network connected and comprising a database, the server comprising:
means for acquiring a source data input from a first user using a first network connected user controlled client, the source data input comprising a source language string and a string identifier;
means for storing the source data input in the database;
means for acquiring a localized data input from a second user using a second network connected user controlled client, the localized data input corresponding to the source data input and comprising a localized text string of the source language string and a language identifier;
means for storing the localization data input in the database;
means for marking the source language string in the database as localized in a target language indicated by the language identifier; and
means for generating at least one data file comprising a predetermined selection of the content from the database in a predetermined data format,
wherein the means for acquiring a source data input and the means for acquiring a localized data input are accessed concurrently.

14. System for localizing text in a software application, the system comprising:
a first network connected user controlled client;
a second network connected user controlled client; and
a server according to any one of claim 13.

15. Computer program product comprising a computer readable medium having stored thereon computer program code for causing a server comprising a database to provide a method for localizing text in a software application, wherein the computer program product comprises:
code for acquiring a source data input from a first user using a first network connected user controlled client, the source data input comprising a source language string and a string identifier;
code for storing the source data input in the database;
code for acquiring a localized data input from a second user using a second network connected user controlled client, the localized data input corresponding to the source data input and comprising a localized text string of the source language string and a language identifier;
code for storing the localization data input in the database;
code for marking the source language string in the database as localized in a target language indicated by the language identifier; and
code for generating at least one data file comprising a predetermined selection of the content from the database in a predetermined data format, wherein the code for acquiring a source data input and the code for acquiring a localized data input are executed concurrently.
